(19) United States
(12) Patent Application Publication
(10) Pub. No.: US 2010/0128173 A1
(43) Pub. Date: May 27, 2010

(54) APPARATUS AND METHOD FOR MOTION ADAPTIVE DEINTERLACING

(75) Inventors: Yu-Mao Lin, Tainan City (TW); Wei-Jen Lo, Hsinchu City (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., Hsinchu (TW)

(21) Appl. No.: 12/483,484

(22) Filed: Jun. 12, 2009

(30) Foreign Application Priority Data
Nov. 25, 2008 (TW) 97145578

(51) Int. Cl. H04N 7/01

(52) U.S. Cl. 348/452; 348/E07.003

(57) ABSTRACT

An apparatus and method for motion adaptive deinterlacing are provided. According to the method, a mean motion of a target pixel is obtained according to the target pixel and multiple neighboring pixels. A specific check area is obtained by setting the target pixel as a center and extending toward both sides of a first direction when the mean motion is higher than a first threshold value. The specific check area stops extending in reaching a pixel with a motion lower than a second threshold value. The second threshold value is lower than the first threshold value. The specific check area stops extending on a tail side of the first direction by reaching a first specific number of pixels from the target pixel. Combing of the specific check area is checked to determine a deinterlacing method for pixels within the specific check area.

This application claims the benefit of Taiwan application Serial No. 97145578, filed Nov. 25, 2008, the subject matter of which is incorporated herein by reference.

### BACKGROUND OF THE INVENTION

1. Field of the invention

The invention relates in general to an apparatus and method for motion adaptive deinterlacing, and particularly to an apparatus and method for motion adaptive deinterlacing to provide high quality display.

2. Description of the Related Art

Nowadays, deinterlacing is a common feature for devices such as televisions, Digital Video Disk(Disc) (DVD) players, and set-top boxes (STB). Deinterlacing is a technique to transform an interlacing signal to a progressive signal; for example, interlacing contents of a standard display (i.e. SD 480i) or a high-definition display (i.e. HD 1080i) would be transformed to a progressive standard display (i.e. SD 480p) or a progressive high-definition display (i.e. HD 1080p) for suitable use on the newly continuous scanning displays, such as liquid crystal displays (LCDs) or plasma displays.

Traditional deinterlacing devices perform motion detection to the input fields, and use the “BOB” method or the “WEAVE” method to deinterlace video contents according to the motion detected. However, the traditional motion detection process would check for areas that are moving to determine if combing occurs thereon. If an area is determined to have combing, motions of the corresponding pixels of the area would be raised higher. Nevertheless, a moving object would include the neighboring static pixels as part of the area for the checking, and the motion of the neighboring static pixels would be improperly raised if these neighboring static pixels happen to have combing patterns; thus, an erroneously method would apply for deinterlacing, which leads to blurring around the moving object on the display.

### SUMMARY

The invention is directed to an apparatus and method for motion adaptive deinterlacing, which is configured to obtain a specific check area under a discreet definition, and to check combing of the specific check area along a plurality of directions, thus reducing blurring.

According to a first aspect of the present invention, an apparatus for motion adaptive deinterlacing is provided, which comprises a motion average unit, a check area defining unit, and a combing check unit. The motion average unit is configured to obtain a mean motion of a target pixel according to the target pixel and a plurality of neighboring pixels. The check area defining unit is configured to obtain a specific check area by setting the target pixel as a center and extending toward both sides of a first direction when the mean motion is higher than a first threshold value, wherein the specific check area stops extending in reaching a pixel with a motion lower than a second threshold value, the second threshold value is lower than the first threshold value, and the specific check area stops extending on a tail side of the first direction by reaching a first specific number of pixels from the target pixel. The combing check unit is configured to check combing of the specific check area for a deinterlacing format determining unit to determine a deinterlacing method for pixels within the specific check area.

According to a second aspect of the present invention, a method for motion adaptive deinterlacing is provided, which comprises: obtaining a mean motion of a target pixel according to the target pixel and a plurality of neighboring pixels; obtaining a specific check area by setting the target pixel as a center and extending toward both sides of a first direction when the mean motion is higher than a first threshold value, wherein the specific check area stops extending in reaching a pixel with a motion lower than a second threshold value, the second threshold value is lower than the first threshold value; and the specific check area stops extending on a tail side of the first direction by reaching a first specific number of pixels from the target pixel; and checking combing of the specific check area to determine a deinterlacing method for pixels within the specific check area.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of an apparatus for motion adaptive deinterlacing according to an embodiment of the invention;

FIG. 2 shows a schematic diagram of the specific checking area according to an embodiment of the invention;

FIG. 3 shows an illustration of a plurality of pixels according to an embodiment of the invention; and

FIG. 4 shows a flowchart of a method for motion adaptive deinterlacing according to an embodiment of the invention.

### DESCRIPTION OF THE EMBODIMENTS

The invention provides an apparatus and method for motion adaptive deinterlacing, which is configured to obtain a specific check area under a discreet definition, and to check combing of the specific check area along a plurality of directions, thus reducing blurring around the moving object on the display.

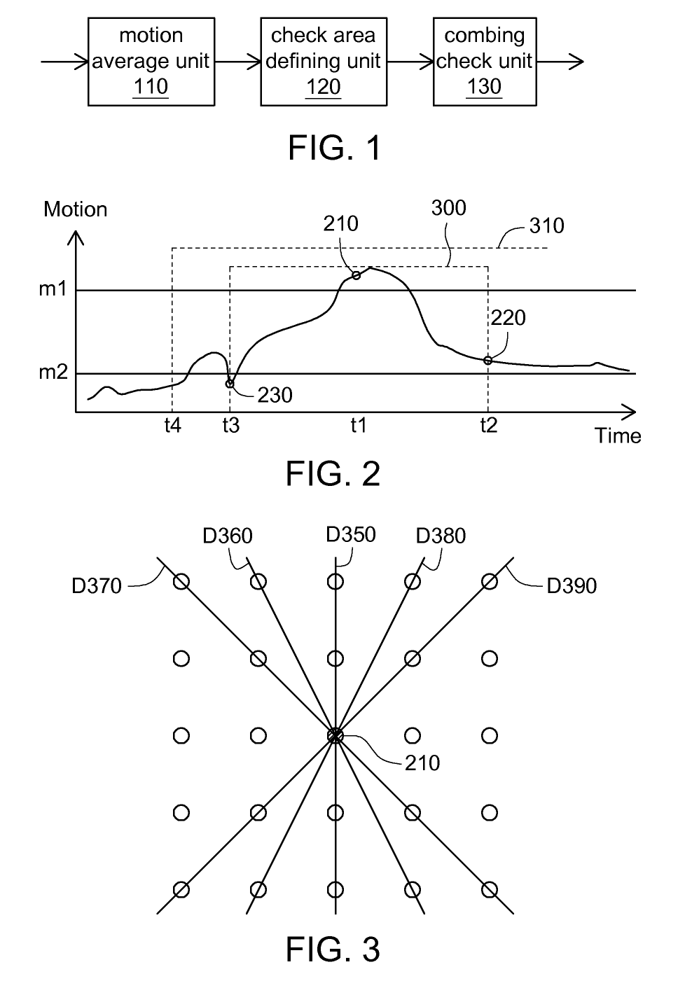

Referring to FIG. 1, a block diagram of an apparatus for motion adaptive deinterlacing according to an embodiment of the invention is shown. The apparatus for motion adaptive deinterlacing 100 includes a motion average unit 110, a check area defining unit 120, and a combing check unit 130. In this embodiment, data of pixels received by the apparatus for motion adaptive deinterlacing 100 is in the form of serial data transmission.

The motion average unit 110 receives data of pixels in serial forms, which includes intensity and motion of each of the pixels, and obtains a mean motion of a target pixel according to the target pixel and the neighboring pixels. Substantially, the motion average unit 110 obtains the mean motion by calculating a mean value of the motions of the target pixel and the neighboring pixels. When the motion average unit 110 obtains the mean motion of the target pixel, the check area defining unit 120 obtains a specific check area according to the mean motion.

Referring to FIG. 2, a schematic diagram of the specific checking area according to an embodiment of the invention is shown. In FIG. 2, a first direction is defined as, but not limited to, a horizontal direction. FIG. 2 can also be viewed as a motion-time scheme for the first pixel to the last pixel along a scan line. If, at time t1, the mean motion of the target pixel 210 is higher than a first threshold value m1, the pixels around time t1 may likely have higher motions. Thus, the check area defining unit 120 sets the target pixel 210 as a center and extends toward both sides of the horizontal direction to obtain the specific check area.

The specific check area stops extending in reaching a pixel with a motion lower than a second threshold value m2, and the second threshold value m2 is lower than the first threshold value m1. If the motion of the pixel is lower than the second threshold value m2, the motion is so low that the pixel would be considered static and not listed in the check area. Furthermore, on a tail side of the horizontal direction, if no pixel is found to have a motion lower than the second threshold value m2 when reaching a first specific number of pixels from the target pixel 210, such as a pixel 220 which is positioned twenty (20) pixels from the target pixel 210, the specific check area stops extending by reaching the pixel 220 at time t2 instead of extending unlimitedly on the tail side. Furthermore, the specific check area stops extending on the tail side of the horizontal direction in reaching a dent, and motions of a part of pixels in the dent are lower than the second threshold value m2.

Furthermore, on a head side of the horizontal direction, the specific check area stops extending in reaching a dent, such as a pixel 230 at time t3, and a motion of the pixel 230 is lower than the second threshold value m2. In addition, the specific check area checks on the head side of the horizontal direction when a pixel exists with a motion higher than a first threshold value m1. In comparison to the traditional method for extending a fixed certain length on the head side of the horizontal direction, the invention considers distribution of the motions and imposes limitations accordingly to obtain a specific check area under a discreet definition.

According to FIG. 2, in comparison to the specific check area 310 found in the traditional method, the specific check area 300 obtained by the check area defining unit 120 is more discreet. Thus, a moving object would not include the neighboring static pixels as part of the check area. Accordingly, less blurring occurs around the moving object, thus effectively reducing text glittering.

Furthermore, if checking is only performed along the horizontal direction, it is possible that the areas with higher motion shatter on the vertical direction. Accordingly, the check area defining unit 120 may further extend toward both sides of a second direction (such as, but not limited to, the vertical direction) to obtain the specific check area. In this way, the specific check area stops extending in reaching a pixel with a motion lower than the second threshold value m2, or by reaching a second specific number of pixels (such as 10 pixels) from the target pixel 210. Thus, the areas with higher motion pixels near the target pixel 210 can be found on the second direction. In this way, the specific check area expands from one-dimensional to two-dimensional, which improves processing of pseudo-still display.

When the check area defining unit 120 obtains the specific check area, the combing check unit 130 checks combing of the specific check area, and sends the checking result to a deinterlacing format determining unit (not shown in the figures). Thus, the deinterlacing format determining unit determines a deinterlacing method for pixels within the specific check area according to the checking result. Referring to FIG. 3, an illustration of a plurality of pixels according to an embodiment of the invention is shown. The combing check unit 130 sets the target pixel as the center and checks combing of the specific check area along a plurality of directions, such as vertical direction D350, an upper-left-to-lower-right diagonal direction D360 or D370, and an upper-right-to-lower-left diagonal direction D380 or D390.

In this way, the combing check unit 130 checks not only the combings on the vertical direction, but also combings on a moving object with diagonal edges, thus enabling all edges of the moving object to be deinterlaced by the “BOB” method to show smoother edges on the display.

Specifically, the pixels having combing within the specific check area are deinterlaced by the “BOB” method, and the pixels without combing can be deinterlaced by other methods such as, but not limited to, the “WEAVE” method or a combined method for the “BOB” method and the “WEAVE” method.

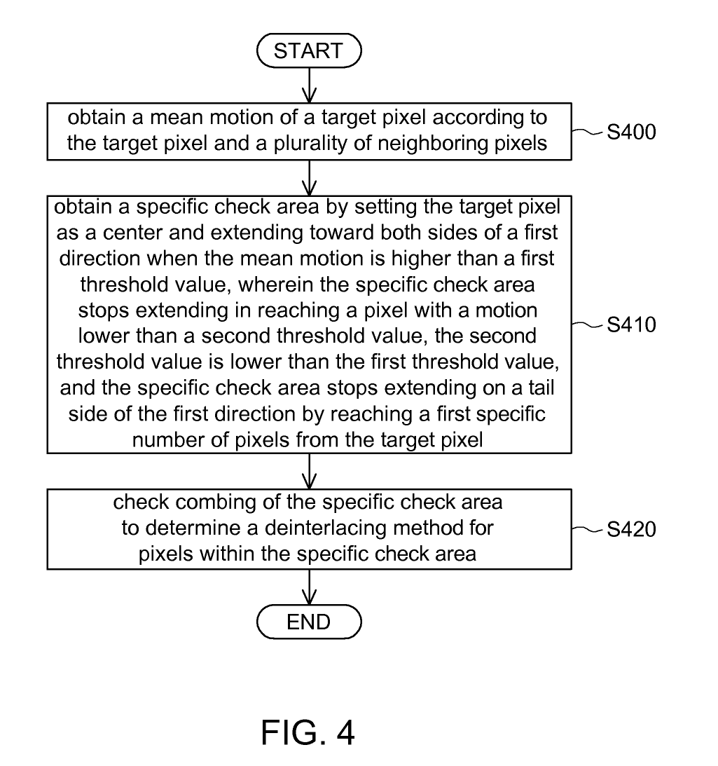

The invention also provides a method for motion adaptive deinterlacing. Referring to FIG. 4, a flowchart of a method for motion adaptive deinterlacing according to an embodiment of the invention is shown. In the step S400, a mean motion of a target pixel is obtained according to the target pixel and a plurality of neighboring pixels. In the step S410, a specific check area is obtained by setting the target pixel as a center and extending toward both sides of a first direction when the mean motion is higher than a first threshold value, in which the specific check area stops extending in reaching a pixel with a motion lower than a second threshold value, the second threshold value is lower than the first threshold value, and the specific check area stops extending on a tail side of the first direction by reaching a first specific number of pixels from the target pixel. In the step S420, combing of the specific check area is checked to determine a deinterlacing method for pixels within the specific check area.

Operations and performances of the method for motion adaptive deinterlacing of the embodiment of the invention have been described in detail in the above-mentioned descriptions of the apparatus for motion adaptive deinterlacing 100, and are not hereinafter described again.

According to the embodiments of the invention, the apparatus and method for motion adaptive deinterlacing are configured to obtain a specific check area under a discreet definition, and to broaden the dimension of the specific check area; thus, a moving object would not include the neighboring static pixels as part of the check area, and processing of pseudo-still display can be improved to reduce glittering. Furthermore, the invention checks the combings on a variety of directions, thus enabling the moving object to show smoother edges on the display and providing high quality display.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for motion adaptive deinterlacing, comprising:
a motion average unit for obtaining a mean motion of a target pixel according to the target pixel and a plurality of neighboring pixels;
a check area defining unit for obtaining a specific check area by setting the target pixel as a center and extending toward both sides of a first direction when the mean motion is higher than a first threshold value, wherein the specific check area stops extending in reaching a pixel with a motion lower than a second threshold value, the second threshold value is lower than the first threshold value, and the specific check area stops extending on a tail side of the first direction by reaching a first specific number of pixels from the target pixel; and
a combing check unit for checking combing of the specific check area for a deinterlacing format determining unit to determine a deinterlacing method for pixels within the specific check area.

2. The apparatus for motion adaptive deinterlacing according to claim 1, wherein the specific check area stops extending on the tail side of the first direction in reaching a dent, and a motion of a pixel in the dent is lower than the second threshold value.

3. The apparatus for motion adaptive deinterlacing according to claim 1, wherein the specific check area stops extending on a head side of the first direction in reaching a dent, and motions of a part of pixels in the dent are lower than the second threshold value.

4. The apparatus for motion adaptive deinterlacing according to claim 1, wherein the first direction is a horizontal direction.

5. The apparatus for motion adaptive deinterlacing according to claim 1, wherein the check area defining unit further extends toward both sides of a second direction to obtain the specific check area, and the specific check area stops extending in reaching a pixel with a motion lower than the second threshold value or by reaching a second specific number of pixels from the target pixel.

6. The apparatus for motion adaptive deinterlacing according to claim 5, wherein the second direction is a vertical direction.

7. The apparatus for motion adaptive deinterlacing according to claim 1, wherein the combing check unit is configured to check combing of the specific check area along a plurality of directions.

8. The apparatus for motion adaptive deinterlacing according to claim 7, wherein the directions comprises a vertical direction, an upper-left-to-lower-right diagonal direction, and an upper-right-to-lower-left diagonal direction.

9. The apparatus for motion adaptive deinterlacing according to claim 1, wherein the pixels having combing within the specific check area are deinterlaced by a “BOB” method.

10. A method for motion adaptive deinterlacing, comprising:
obtaining a mean motion of a target pixel according to the target pixel and a plurality of neighboring pixels;
obtaining a specific check area by setting the target pixel as a center and extending toward both sides of a first direction when the mean motion is higher than a first threshold value, wherein the specific check area stops extending in reaching a pixel with a motion lower than a second threshold value, the second threshold value is lower than the first threshold value, and the specific check area stops extending on a tail side of the first direction by reaching a first specific number of pixels from the target pixel; and
checking combing of the specific check area to determine a deinterlacing method for pixels within the specific check area.

11. The method for motion adaptive deinterlacing according to claim 10, wherein the specific check area stops extending on the tail side of the first direction in reaching a dent, and motions of a part of pixels in the dent are lower than the second threshold value.

12. The method for motion adaptive deinterlacing according to claim 10, wherein the specific check area stops extending on a head side of the first direction in reaching a dent, and a motion of a pixel in the dent is lower than the second threshold value.

13. The method for motion adaptive deinterlacing according to claim 10, wherein the first direction is a horizontal direction.

14. The method for motion adaptive deinterlacing according to claim 10, further comprising:
obtaining the specific check area by extending toward both sides of a second direction, wherein the specific check area stops extending in reaching a pixel with a motion lower than the second threshold value or by reaching a second specific number of pixels from the target pixel.

15. The method for motion adaptive deinterlacing according to claim 14, wherein the second direction is a vertical direction.

16. The method for motion adaptive deinterlacing according to claim 10, further comprising:
checking combing of the specific check area along a plurality of directions.

17. The method for motion adaptive deinterlacing according to claim 16, wherein the directions comprises a vertical direction, an upper-left-to-lower-right diagonal direction, and an upper-right-to-lower-left diagonal direction.

18. The method for motion adaptive deinterlacing according to claim 10, further comprising deinterlacing the pixels having combing within the specific check area by a “BOB” method.
